(19) United States
(12) Patent Application Publication
(10) Pub. No.: US 2025/0074783 A1
(43) Pub. Date: Mar. 6, 2025

(54) DECORATIVE ARTICLE HAVING BIO-HYBRID NANO-PARTICLE PHOTONIC CRYSTAL STRUCTURE, AND METHOD OF MANAUFACTURE THEREOF

(71) Applicant: FCA US LLC, Auburn Hills, MI (US)

(72) Inventors: Sathishkumar Murugesan, Salem District (IN); Shweta Kulkarni, Pune (IN)

(21) Appl. No.: 18/457,615

(22) Filed: Aug. 29, 2023

(51) Int. Cl. C01F 11/06; B05D 5/06; C08K 3/22

(52) U.S. Cl. CPC C01F 11/06; B05D 5/065; C08K 3/22; B05D 2201/02; B05D 2301/00; B05D 2502/00; C01P 2004/64; C08K 2003/2206; C08K 2201/011; C08K 2201/013

(57) ABSTRACT

A method for manufacturing a decorative article that may include decomposing a bio-waste source of CaCO₃ into CaO; subjecting the CaO to a graining process to form a plurality of nano-sized particles having a particle size up to 20 nm; ejecting a solution containing the plurality of nano-sized particles to a first substrate; placing the first substrate including the plurality of nano-sized particles into a mold; and injecting a polymeric resin into the mold to form a molded article including a coating layer that includes the plurality of nano-sized particles.

### FIELD

The present disclosure relates to a decorative article having a bio-hybrid nano-particle photonic crystal structure, and to a method of manufacturing the decorative part.

### BACKGROUND

This section provides background information related to the present disclosure which is not necessarily prior art.

Decorative parts of a vehicle such as, for example, a decorative badge displaying a logo of the vehicle are currently manufactured using pigment-based paints and chrome plating. These decorative parts, however, may lose gloss over an extended period of time, the color of the decorative part may fade, and the part may corrode. In addition, the pigment-based paints and chrome plating may be detrimental to the environment due to the use of heavy metals and other materials such as oil-based solvents.

### SUMMARY

This section provides a general summary of the disclosure and is not a comprehensive disclosure of its full scope or all of its features.

According to a first aspect, the present disclosure provides a method for manufacturing a decorative article that may include decomposing a bio-waste source of CaCO₃ into CaO; subjecting the CaO to a graining process to form a plurality of nano-sized particles having a particle size up to 20 nm; ejecting a solution containing the plurality of nano-sized particles to a first substrate; placing the first substrate including the plurality of nano-sized particles into a mold; and injecting a polymeric resin into the mold to form a molded article including a coating layer that includes the plurality of nano-sized particles.

According to the first aspect, the solution includes a solvent, and the method may further include evaporating the solvent before placing the first substrate including the plurality of nano-sized particles into the mold.

According to the first aspect, the step of ejecting the solution to the first substrate includes depositing the solution in a positive pattern on the first substrate.

According to the first aspect, the method may further include ejecting the solution containing the plurality of nano-sized particles to a second substrate; and placing the second substrate including the plurality of nano-sized particles into the mold.

According to the first aspect, the step of ejecting the solution to the second substrate may include depositing the solution in a negative pattern on the second substrate.

According to the first aspect, each of the positive pattern and the negative pattern may include a plurality of layers of the nano-sized particles.

According to the first aspect, a cumulative thickness of the plurality of layers of each of the positive pattern and the negative pattern may be 50 to 750 nm.

According to the first aspect, the first substrate may be formed of a material including polyetheretherketone.

According to the first aspect, the polymeric resin may include polymethylmethacrylate.

According to the first aspect, a temperature during the injecting of the polymeric resin may be about 240 degrees C.

According to the first aspect, the bio-waste source of CaCO₃ may be at least one of egg shells and sea shells.

According to the first aspect, the solution does not contain a pigment or heavy metals.

According to the first aspect, after ejecting the solution containing the plurality of nano-sized particles to the first substrate and evaporating the solvent, the method may further include inspecting the nano-sized particles to confirm formation of a photonic crystal structure including the plurality of nano-sized particles.

According to the first aspect, the method may further include depositing structural patterns on the molded article.

According to the first aspect, the method may further include removing the first substrate from the molded product.

According to a second aspect of the present disclosure, there is provided a decorative article that is manufactured according to the first aspect of the present disclosure.

According to the second aspect, the decorative article may include a core formed of the polymeric resin and the coating layer formed on the core.

According to the second aspect, the coating layer may include the plurality of nano-sized particles arranged in a photonic crystal structure.

According to the second aspect, the photonic crystal structure is configured to reflect ambient light, and the reflected light includes a plurality of colors.

According to the second aspect, a color of the reflective light changes based on an angle of an observer relative to the photonic structure, and a distance that the ambient light travels through the photonic crystal structure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle including a decorative article according to a principle of the present disclosure;

FIG. 2 is an overhead perspective view of a decorative article located on the vehicle illustrated in FIG. 1;

FIG. 3 is a cross-sectional view along the line 3-3 shown in FIG. 2;

FIG. 4 is a perspective view of an example photonic crystal structure that is part of the decorative article illustrated in FIGS. 2 and 3;

FIG. 5 is a flow-chart illustrating an example method according to a principle of the present disclosure; and

FIG. 6 is a schematic illustration of how the decorative article reflects light according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

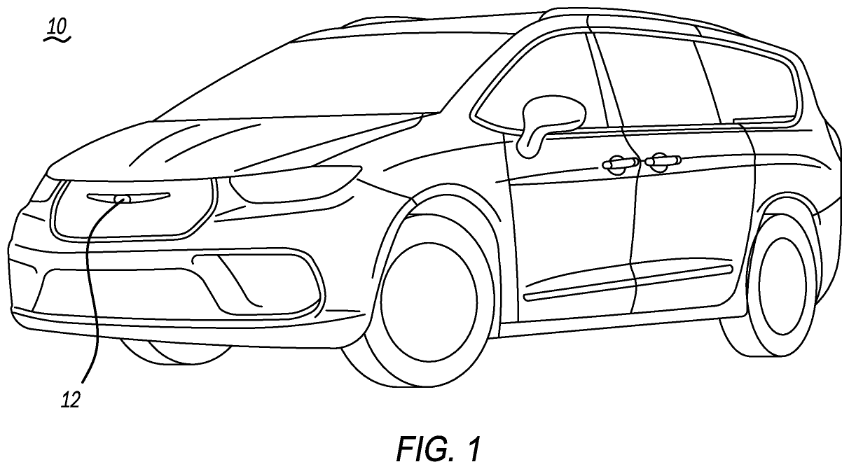

FIG. 1 illustrates a vehicle 10 having a decorative part or badge 12. Badge 12 can be used to indicate the manufacturer of vehicle 10. While badge 12 is illustrated as being formed at a front of vehicle 10, it should be understood that badge 12 may be located anywhere on vehicle 10, or a plurality of badges 12 may be located on vehicle 10. Badge 12 may be formed of a polymeric material or a metal material, as is known to one skilled in the art. To provide an aesthetic appearance to badge 12, badge 12 may be colored using various pigment-based materials or plated with chrome. As noted above, however, these materials may lose gloss over an extended period of time, the color may fade, and the badge 12 (if formed of a metal material) may corrode. In addition, the pigment-based paints and chrome plating may be detrimental to the environment due to the use of heavy metals and other materials such as oil-based solvents.

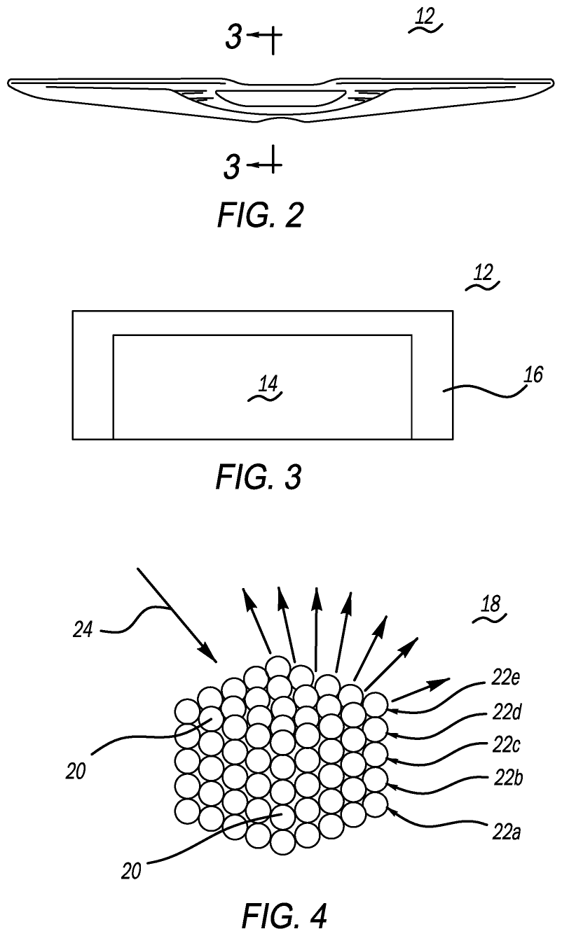

In view of the above, the present disclosure provides a decorative article or badge 12 that is configured to display multiple colors and is formed of materials that are not detrimental to the environment. More particularly, referring to FIG. 2, badge 12 may be formed of a core 14 that is formed of a polymeric material, and core 14 may include an exterior layer or coating 16 having a photonic crystal structure 18 (FIG. 3) that is configured to reflect ambient light (e.g., sunlight) at various wavelengths to alter an appearance of badge 12.

Moreover, it should be understood that coating 16 containing the photonic crystal structure 18 may be formed of materials generated from bio-waste such that, in contrast to pigment-based paints and chrome, formation of coating 16 does not provide any negative effects on the environment. Put another way, the crystals 20 of photonic crystal structure 18 may be formed of materials generated from bio-waste such that badge 12 does not include materials such as pigments, heavy metals, and the like, are resistant to losing gloss, are resistant to fading, and do not corrode. While badge 12 is illustrated in FIG. 3 as having a core 14 and an outer layer or coating 16 that includes the photonic crystal structure 18, it should be understood that core 14 is not necessarily required. In contrast, badge 12 may consist solely of coating 16 having photonic crystal structure 18, and the polymeric material may be dispersed between respective crystals 20 of crystal structure 18. Example polymeric materials that may be used for core 14 or dispersed between crystals 20 of photonic crystal structure 18 include (meth)acrylic resins, which have excellent transparency and weather resistance. Example (meth)acrylic resins include polymethylmethacrylate (PMMA), which in addition to excellent transparency and weather resistance, provides good gloss.

The bio-waste that may be used to form crystals 20 of photonic crystal structure 18 may be a material that can be decomposed into calcium oxide (CaO). Example bio-waste materials that can be decomposed into CaO include egg shells and seashells. Other materials that can be decomposed into CaO include naturally occurring materials such as limestone (CaCO₃). Similar to limestone, egg shells are formed substantially of CaCO₃ (i.e., about 96%).

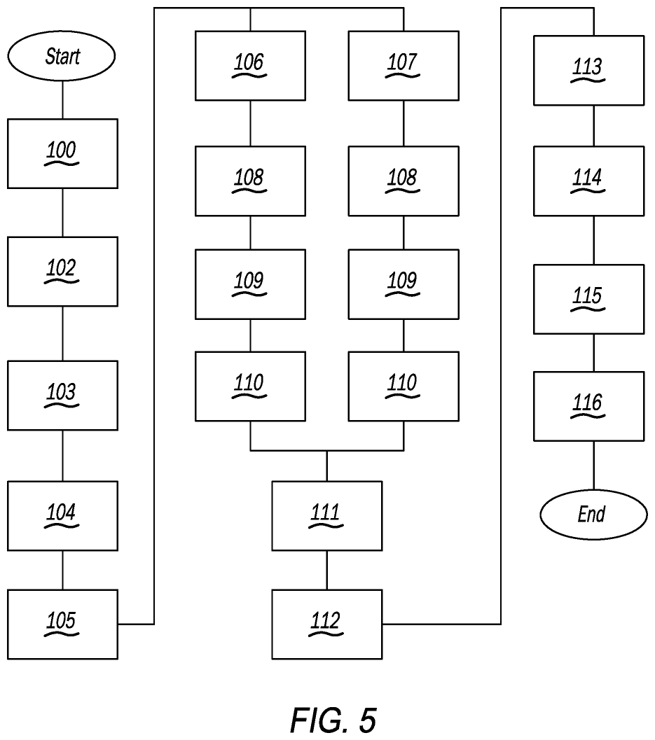

Now referring to FIG. 5, a method for manufacturing badge 12 will be described. Firstly, in step 100, the bio-waste that is to be decomposed into CaO is selected. In this example embodiment, the selected bio-waste is egg shells. After the bio-waste is selected, the egg shells are treated with a solvent such as acetone (step 102) to remove various layers of the egg shells (e.g., membranes) that are not formed of CaCO₃. After the various layers of the egg shells are removed, the egg shells that do not include the removed layers may be rinsed before heating the egg shells at a temperature of 900 degrees C. or greater (step 103). As the egg shells are heated to this temperature, the egg shells will decompose and release carbon dioxide (CO₂) to yield CaO, which is a white solid. Once the CaO is obtained, the solid CaO material will undergo a graining process (step 104) to form nano-sized particles. A particle size of the nano-sized particles may be up to about 20 nm, preferably up to about 15 nm, and more preferably up to about 10 nm. The graining process may include multiple steps to ensure that the nano-sized particles are each about the same size (e.g., up to about 20 nm or less).

After the CaO material is ground to provide a plurality of nano-sized particles having the desired particle size, the nano-sized particles are mixed with solvent (step 105) to form a solution containing the nano-sized particles. An example solvent includes ethanol, but other solvents such as methanol, isopropyl alcohol, polyhydric alcohols, glycols, and the like may be used. After forming the solution in step 105, the solution may be printed to a first substrate formed of a material such as polyetheretherketone (PEEK) and a second substrate formed of a material such as silicone using, for example, an electro-hydrodynamic (EHD) injection method (steps 106 and 107), which is a high-resolution printing process. Other printing methods include ink jet printing. The selected printing process may be any printing process known to one skilled in the art that is high resolution, and able to eject a solution containing nano-sized particles.

The selected printing method may deposit the solution on the first substrate to form a first pattern (step 106), which may be a positive pattern. The selected printing may deposit the solution on the second substrate to form a second pattern (step 107), which may be a negative pattern. The positive pattern may be a pattern that is of interest to the observer (e.g., a logo), while the negative pattern may be a background of the positive pattern or an area that surrounds the positive pattern. After the first and second patterns are formed on the first and second substrates, respectively, the solvent (e.g., ethanol) of the solution is evaporated (step 108), leaving the nano-sized particles deposited in the desired patterns on the respective substrate.

The first and second patterns formed on the first and second substrates, respectively, may each include a plurality of layers of the nano-sized particles. Indeed, again referring to FIG. 4, it can be seen that the photonic crystal structure 18 includes a plurality of layers 22a, 22b, 22c, 22d, and 22e. A greater or lesser number of layers may be used, as desired. Moreover, while the particles 20 are illustrated as being aligned with each other in each layer (i.e., the particles 20 of one layer (e.g., 22a) are aligned with the particles 20 of another layer (e.g., 22b), it should be understood that such a configuration is not necessarily required. In contrast, the particles 20 of one layer (e.g., 22a) may be staggered relative to the particles 20 of another layer (e.g., 22b).

Once the positive and negative patterns are formed and the solvent evaporated, the positive and negative patterns may be inspected using, for example, an x-ray diffraction method, a scanning electron microscope (SEM) method, or by using each of these methods (step 109). The x-ray diffraction and SEM methods determine whether the photonic crystal structure 18 has been synthesized.

After determining whether the photonic crystal structures 18 have been synthesized in step 109, the first and second patterns are evaluated to determine whether the particles 20 of the photonic crystal structure 18 are aligned in the desired manner, whether any errors occurred during deposition of the solution containing the particles 20 using the selected printing process (e.g., whether there are any undesirable gaps or voids in the first and second patterns that would result in a final product having undesirable reflection properties), and whether the first and second patterns have the desired thickness (e.g., number of layers 22) (step 110). In general, the desired thickness of the first and second patterns is in the range of 50 to 750 nm. The thickness of the first and second patterns can be determined based on the desired wavelength of light to be reflected by the particles of the photonic crystal structure.

If after the evaluation conducted in step 110 it is determined that errors occurred during the deposition process, the first and second patterns may be modified, if necessary. In this regard, if based on the result of the inspection in step 110 that either of the first and second patterns includes undesired gaps or voids, another printing process can be conducted to fill in the gaps or voids. Moreover, if the thickness of the first and second patterns is less that that desired, another printing process can be conducted to increase the thickness of the first and second patterns. Steps may also be taken to decrease a thickness of the first and second patterns or remove portions of the first and second patterns, if necessary.

Next, the first substrate including the first pattern and the second substrate including the second pattern may be placed in a mold (step 111). Once the first and second substrates are placed in the mold, the first and second substrates can be patterned and sized to account for the design of the mold (step 112). The first and second substrates can be patterned and sized using, for example, a wet etching process.

Once the first and second substrates are patterned and sized to account for the design of the mold in step 120, an acrylic resin such as PMMA is injected into the mold (step 113). Preferably, after the polymeric resin material is injected into the mold at a temperature of about 240 degrees C., the resin is cured. As noted above, the badge 12 may include a core 14 formed of the resin material and a coating 16 including the photonic crystal structure 18 positioned on the core 14. Alternatively, badge 12 may consist solely of coating 16 having photonic crystal structure 18, and the polymeric material may be dispersed between respective crystals 20 of crystal structure 18.

After injecting the polymeric resin into the mold, the method includes adjusting various parameters of the molding process to ensure that the photonic crystal structures 18 are properly deposited on the molded product (step 114) (i.e., on the PMMA resin). In this regard, to ensure that the photonic crystal structures 18 are located on the resin correctly to ensure that the photonic crystal structures 18 of the final product reflect light in the desired manner, parameters during the molding process that can be adjusted include a temperature of the mold, molding pressures, and the length (time) of the molding process. These parameters can be tailored according to the resin used for the molded product (i.e., resins other than PMMA may require, for example, different molding pressures and temperatures).

After depositing the patterns of the photonic crystal structures 18 on the resin material, the molded product can be removed from the mold and the first and second substrates may be removed by etching (step 115) or some other type of removal process. The badge 12 then undergoes a final inspection (step 116) to determine whether badge 12 is acceptable for being placed on the vehicle 10.

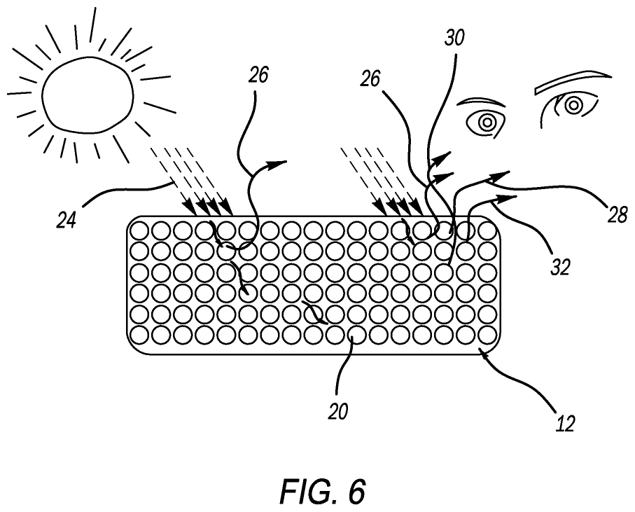

It should be understood that the particles 20 of the photonic crystal structure 18 do not function in the same manner as a pigment. That is, the particles 20 do not have a specific color. In contrast, the color reflected by the particles 20 of the photonic crystal structure is dependent on the angle at which ambient light impinges on the particles 20 or the angle of the observer relative to the badge 12. Indeed, referring to FIG. 6, a badge 12 having particles 20 dispersed throughout a resin of the badge 12 is illustrated (it should be understood that the size of particles 20 in FIG. 6 is exaggerated for illustration purposes). As can be seen in FIG. 6, the angle at which sunlight 24 impinges on the particles 20 can result in a violet color 26 being reflected, while the observer sees light of different colors red 28, green 30, and blue 32 in addition to violet 26 because the angle at which the observer views the reflected flight is different from the angle at which the sunlight 24 impinges on the particles 20.

Another factor that affects the color of the light reflected by the photonic crystal structure 18, in conjunction with the angle at which the ambient light impinges on the particles 20 or the angle of the observer relative to the badge 12, is the distance that the ambient light travels through layers 22a-22e. For example, if the ambient light travels through the layers 22a-22e a distance in the range of about 625 to about 740 nm the color of the light reflected by the photonic crystal structure 18 can be red. Conversely, if the light travels through the layers 22a-22e a distance in the range of about 445 to about 520 nm the color of the light reflected by the photonic crystal structure 18 can be blue. The below Table 1 summarizes the colors that may be reflected based on the distance that the light travels through the photonic crystal structure 18. No additional coloring agents such as dyes or pigments are used to color badge 12.

TABLE 1

| Color | Distance Traveled (nm) |
|---|---|
| Violet | 380-450 |
| Blue | 450-495 |
| Green | 495-570 |
| Yellow | 570-590 |
| Orange | 590-620 |
| Red | 620-750 |

According to the above described embodiments, a decorative article can be produced that can reflect various different colors to alter the appearance of the decorative article depending on the angle of the ambient light that impinges on the article, the angle of the observer relative to the article, and a distance that the ambient light travels through the photonic crystal structure 18 of the article. Color plays a role in enhancing the quality of decorative articles as perceived by the observer, and different colors can be associated with different emotions. Thus, because the decorative article can reflect multiple colors, the light reflected by the decorative article can affect the emotions and moods of the observer viewing the different colors reflected by the article, which may assist in improving observer experience and potentially influence the observer in one or more ways.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for manufacturing a decorative article, comprising:
decomposing a bio-waste source of CaCO₃ into CaO;
subjecting the CaO to a graining process to form a plurality of nano-sized particles having a particle size up to 20 nm;
ejecting a solution containing the plurality of nano-sized particles to a first substrate;
placing the first substrate including the plurality of nano-sized particles into a mold; and
injecting a polymeric resin into the mold to form a molded article including a coating layer that includes the plurality of nano-sized particles.

2. The method according to claim 1, wherein the solution includes a solvent, and the method further comprises evaporating the solvent before placing the first substrate including the plurality of nano-sized particles into the mold.

3. The method according to claim 1, wherein the step of ejecting the solution to the first substrate includes depositing the solution in a positive pattern on the first substrate.

4. The method according to claim 3, further comprising ejecting the solution containing the plurality of nano-sized particles to a second substrate; and
placing the second substrate including the plurality of nano-sized particles into the mold.

5. The method according to claim 4, wherein the step of ejecting the solution to the second substrate includes depositing the solution in a negative pattern on the second substrate.

6. The method according to claim 5, wherein each of the positive pattern and the negative pattern include a plurality of layers of the nano-sized particles.

7. The method according to claim 6, wherein a cumulative thickness of the plurality of layers of each of the positive pattern and the negative pattern is 50 to 750 nm.

8. The method according to claim 1, wherein the first substrate is formed of a material including polyetheretherketone.

9. The method according to claim 1, wherein the polymeric resin includes polymethylmethacrylate.

10. The method according to claim 1, wherein a temperature during the injecting of the polymeric resin is about 240 degrees C.

11. The method according to claim 1, wherein the bio-waste source of CaCO₃ is at least one of egg shells and sea shells.

12. The method according to claim 1, wherein the solution does not contain a pigment or heavy metals.

13. The method according to claim 2, wherein after ejecting the solution containing the plurality of nano-sized particles to the first substrate and evaporating the solvent, the method further comprises inspecting the nano-sized particles to confirm formation of a photonic crystal structure including the plurality of nano-sized particles.

14. The method according to claim 13, further comprising depositing structural patterns on the molded article.

15. The method according to claim 14, further comprising removing the first substrate from the molded product.

16. A decorative article manufactured according to the method of claim 1.

17. The decorative article according to claim 16, wherein the decorative article includes a core formed of the polymeric resin and the coating layer formed on the core.

18. The decorative article according to claim 17, wherein the coating layer includes the plurality of nano-sized particles arranged in a photonic crystal structure.

19. The decorative article according to claim 18, wherein the photonic crystal structure is configured to reflect ambient light, and the reflected light includes a plurality of colors.

20. The decorative article according to claim 19, wherein a color of the reflective light changes based on an angle of an observer relative to the photonic structure, and a distance that the ambient light travels through the photonic crystal structure.
